(19) United States
(12) Patent Application Publication
(10) Pub. No.: US 2006/0082099 A1
(43) Pub. Date: Apr. 20, 2006

(54) Gooseneck Trailer Hitch for Tractors

(76) Inventor: Al Jwanouskos, Hendrix, OK (US)

Correspondence Address: LAW OFFICE OF MICHAEL R. NICHOLS, 3001 S. HARDIN BLVD. STE. 110, PMB #155, MCKINNEY, TX, 75070, US

(21) Appl. No.: 11/163,581

(22) Filed: Oct. 24, 2005

Related U.S. Application Data
(63) Continuation of application No. PCT/US05/30103, filed on Aug. 23, 2005.
(60) Provisional application No. 60/522,166, filed on Aug. 23, 2004.

(51) Int. Cl. B60D 1/14

(52) U.S. Cl. 280/416.2

(57) ABSTRACT

A hitch device enabling a three-point tractor hitch to be attached to a gooseneck trailer or other similar apparatus (such as a fifth-wheel trailer) is disclosed. A preferred embodiment of the present invention comprises a tubular member having a generally arcuate shape, to which a trailer hitch ball and a pair of metal rods, which function as hitch pins, are welded. Two brackets are welded to the tubular member and serve to support an additional hitch pin. The welded metal rods and additional hitch pin may be secured to a three-point hitch using cotters or other suitable fastener. The device elevates the trailer hitch ball to a sufficient height to accommodate a gooseneck trailer's point of attachment.

### TECHNICAL FIELD

The present invention relates generally to attachments and accessories for tractors or trailers. More specifically, the present invention provides a trailer hitch that may be used to connect a tractor with a three-point-type hitch to a gooseneck trailer or other similar apparatus.

### BACKGROUND ART

A gooseneck trailer is a common configuration of trailer used primarily in agriculture for hauling large loads, such as hay bales or animals. Gooseneck trailers are named for their characteristic attachment point, which resembles the long, slender neck of a goose. The “gooseneck” portion of the trailer extends downward from the top of the trailer to meet the trailer hitch ball of a suitable trailer hitch. Gooseneck trailers generally require a different type of hitch than ordinary trailers, since the point of attachment on a gooseneck trailer is at a higher elevation (usually about a foot higher) than that of a standard trailer. Gooseneck trailer hitches are readily available for use with trucks.

In the agricultural field, however, the tractor is the modern farmer/rancher's workhorse. Tractors are used for everything from cultivating soil to baling hay. In many instances, a farmer or rancher will have a need to make use of his tractor in conjunction with a gooseneck trailer. For example, a rancher may wish to bale hay, then load a number of hay bales onto a gooseneck trailer for transport and subsequent storage. Gooseneck trailer hitches that allow connection to tractors are not readily available, however.

A number of devices have been proposed in the art to allow the connection of a gooseneck trailer to a tractor having a standard three-point point hitch, such as U.S. Pat. No. 4,340,240 (ANDERSON) Jul. 20, 1982, U.S. Pat. No. 5,984,019 (HUND) Nov. 16, 1999, U.S. Pat. No. 6,612,380 (PYLE) Sep. 2, 2003, and U.S. Pat. No. 6,125,945 (SKAGGS ET AL.) Oct. 3, 2000. All of these designs, however, suffer from a number of drawbacks that limit their utility, as well as their economic and commercial viability. In particular, these designs involve complex assemblies that may be difficult and costly to manufacture. Further, a number of these designs suffer from excessive bulk and complexity of use.

Thus, what is needed is a simple, economical device for connecting a three-point tractor hitch to a gooseneck trailer or other similar device. The present invention provides a solution to this and other problems, and offers other advantages over previous solutions.

### SUMMARY OF THE INVENTION

A preferred embodiment provides a hitch device enabling a three-point tractor hitch to be attached to a gooseneck trailer or other similar apparatus (such as a fifth-wheel trailer). A preferred embodiment of the present invention comprises a tubular member having a generally arcuate shape, to which a trailer hitch ball and a pair of metal rods, which function as hitch pins, are welded. Two brackets are welded to the tubular member and serve to support an additional hitch pin. The welded metal rods and additional hitch pin may be secured to a three-point hitch using cotters or other suitable fastener. The device elevates the trailer hitch ball to a sufficient height to accommodate a gooseneck trailer's point of attachment.

These and various other features and advantages that characterize the present invention will be apparent upon reading of the following detailed description and review of the associated drawings.

### BRIEF DESCRIPTION OF THE DRAWINGS

The present invention may be better understood, and its numerous objects, features, and advantages made apparent to those skilled in the art by referencing the accompanying drawings. The use of the same reference symbols in different drawings indicates similar or identical items.

FIG. 1 is a pictorial diagram depicting a preferred embodiment of the present invention in an isometric projection;

FIG. 2 is a diagram depicting a preferred embodiment of the present invention, including a hitch pin, in front view;

FIG. 3 is a pictorial diagram, in isometric projection, depicting a connection of a preferred embodiment of the present invention to a three-point tractor hitch; and

FIG. 4 is a pictorial diagram, in isometric projection, depicting an alternative embodiment of the present invention in which a support for a second trailer hitch ball is provided.

### DETAILED DESCRIPTION

The following is intended to provide a detailed description of an example of the invention and should not be taken to be limiting of the invention itself. Rather, any number of variations may fall within the scope of the invention, which is defined in the claims following the description.

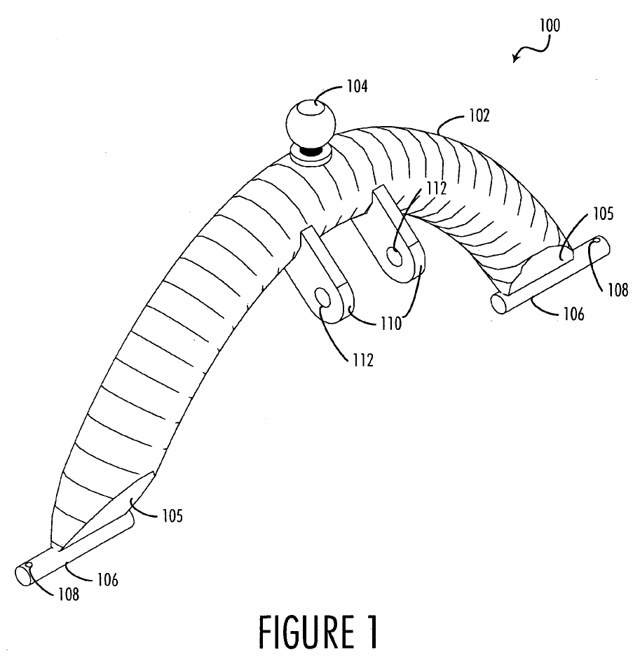

FIG. 1 is a pictorial diagram, in isometric projection, depicting a gooseneck trailer hitch 100 in accordance with a preferred embodiment of the present invention. Hitch 100 comprises an arcuate tubular member 102, which is constructed from a segment of metal pipe that has been bent into the shape of an arch. In this preferred embodiment, tubular member 102 is constructed from 3″-diameter steel pipe. A trailer hitch ball 104 is welded to the apex of tubular member 102.

The ends 105 of tubular member 102 are tapered to form a roughly linear cross-section at the extreme ends of tubular member 102, where tubular member 102 is welded to metal rods 106, each of which projects outward from tubular member 102 in a horizontal direction and serves the function of a hitch pin. Each of metal rods 106 is sized, therefore, to accommodate the inner diameter of a hitch link in a three-point tractor hitch. Each metal rod 106 has a cylindrical bore 108 that extends across the diameter of metal rod 106. Each cylindrical bore 108 is sized to accommodate a cotter or other suitable fastener.

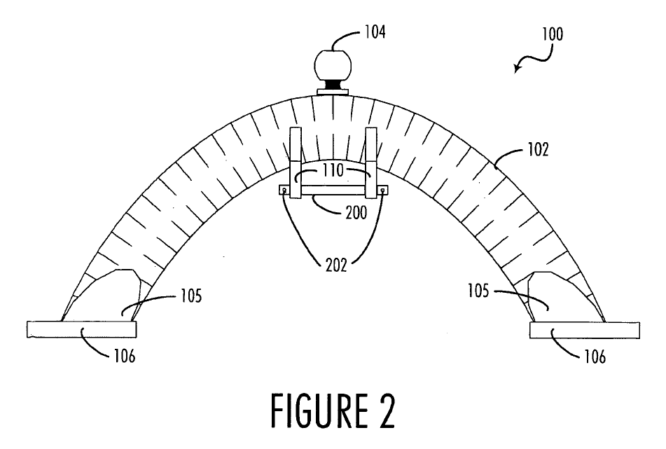

A pair of brackets 110 are welded to and extend outward from tubular member 102. Each of brackets 110 contains a cylindrical bore 112 that is sized to accommodate the diameter of a hitch pin. As shown in FIG. 2, which provides a front-facing view of hitch 100, a hitch pin 200 is inserted through cylindrical bores 112 and is supported from tubular member 102 by brackets 110. Hitch pin 200 is drilled with cylindrical bores 202 on each end to accommodate a pair of cotters or other suitable fastener.

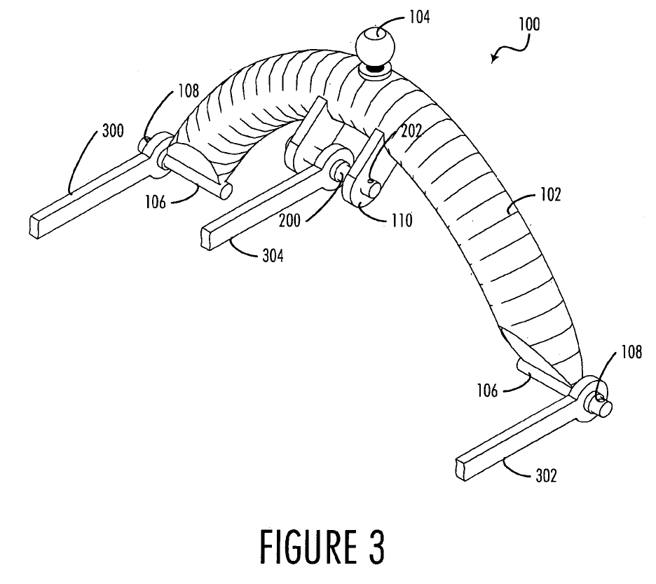

FIG. 3 depicts a manner of using a preferred embodiment of the present invention to equip a tractor having a three-point hitch to a gooseneck trailer or other similarly constructed apparatus. The three-point hitch provided by the tractor consists of hitch links 300, 302, and 304, which extend rearward from the tractor. Hitch 100 is attached to the tractor at metal rods 106 and hitch pin 200. Specifically, hitch links 300 and 302 are slipped over metal rods 106 and hitch pin 200 is inserted through brackets 110 and hitch link 304, with hitch link 304 being positioned between brackets 110, as depicted in FIG. 3. Hitch links 300, 302, and 304 are then held securely in place by inserting cotters or other suitable fastener (not shown) through bores 108 and 202.

The configuration of a preferred embodiment of the present invention, as depicted in FIG. 3, allows trailer hitch ball 104 to be elevated approximately one foot higher than metal rods 106. This allows a gooseneck trailer or other similarly dimensioned apparatus to be attached to the tractor.

The arch-like design of hitch 100 has a number of distinct advantages over known tractor hitch designs. Firstly, the arch shape provides clearance for a power take-off (PTO) shaft or other apparatus. Second, hitch 100 is of essentially uniform construction (with the exception of hitch pin 202), which enhances the durability and practicality of the device, since there are fewer pieces to lose or break. Third, the design of hitch 100 reduces the bulk and weight of the device to a minimum, making hitch 100 readily portable and storable when not in use. Fourth, hitch 100's space-saving, low-profile design reduces the likelihood of hitch 100 coming into contact with or becoming caught on external foreign objects while in transit.

One of ordinary skill in the art will recognize that a number of variations on the preferred design described here are possible and may be achieved without departing from the scope and spirit of the present invention. A few of these are discussed here. In one possible embodiment of the invention, tubular member 102, instead of forming a curvilinear arc, is constructed in a piecewise linear shape (e.g., from a number of straight segments welded end to end or from angular bending).

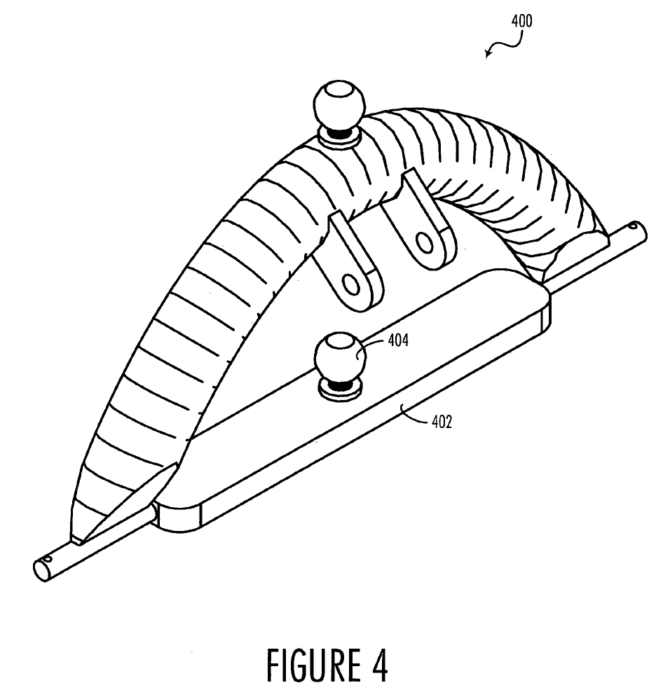

In another possible embodiment of the invention, shown in FIG. 4, a horizontal cross-piece 402 extends across the bottom of hitch 400. A second hitch ball 404 is affixed to cross-piece 402. This arrangement allows hitch 400 to be used in conjunction with both gooseneck and conventional trailer types.

While particular embodiments of the present invention have been shown and described, it will be obvious to those skilled in the art that, based upon the teachings herein, changes and modifications may be made without departing from this invention and its broader aspects and, therefore, the appended claims are to encompass within their scope all such changes and modifications as are within the true spirit and scope of this invention. Furthermore, it is to be understood that the invention is solely defined by the appended claims. It will be understood by those with skill in the art that is a specific number of an introduced claim element is intended, such intent will be explicitly recited in the claim, and in the absence of such recitation no such limitation is present. For non-limiting example, as an aid to understanding, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to inventions containing only one such element, even when the same claim includes the introductory phrases “one or more” or “at least one” and indefinite articles such as “a” or “an”; the same holds true for the use in the claims of definite articles.

What is claimed is:

1. An apparatus for attaching a gooseneck trailer to a tractor, comprising:
a generally arcuate member having first and second ends;
a trailer hitch component connected to the generally arcuate member;
a first generally cylindrical rod connected to the first end of the generally arcuate member, wherein the first generally cylindrical rod is adapted to connect to a first hitch link of a three-point tractor hitch;
a second generally cylindrical rod connected to the second end of the generally arcuate member, wherein the second generally cylindrical rod is adapted to connect to a second hitch link of a three-point tractor hitch; and
a plurality of hitch pin supporting components connected to the generally arcuate member, wherein the hitch pin support components are adapted to support a hitch pin that is adapted to connect to a third link of a three-point tractor hitch.

2. The apparatus of claim 1, wherein the trailer hitch component is a trailer hitch ball.

3. The apparatus of claim 1, wherein the plurality of hitch pin support components include hitch pin supporting brackets, wherein each of the hitch pin supporting brackets contains a bore, through which a hitch pin may be inserted.

4. The apparatus of claim 1, wherein the first generally cylindrical rod, the second generally cylindrical rod, the generally arcuate member, and the plurality of hitch pin supporting components form a structure of unitary construction.

5. The apparatus of claim 1, wherein the generally arcuate member is formed from a tubular piece of material.

6. The apparatus of claim 5, wherein the tubular piece of material is tapered at the first and second ends of the generally arcuate member.

7. The apparatus of claim 1, wherein the generally arcuate member is made of metal.

8. The apparatus of claim 7, wherein the first and second generally cylindrical rods, the trailer hitch component, and the hitch pin supporting components are made of metal.

9. The apparatus of claim 8, wherein the first and second generally cylindrical rods, the trailer hitch component, and the hitch pin supporting components are welded to the generally arcuate member.

10. The apparatus of claim 9, wherein the generally arcuate member includes a plurality of straight members that are angularly connected to each other.

11. The apparatus of claim 10, wherein the first and second generally cylindrical rods each include a bore, wherein the bore is adapted to accommodate a fastener.

12. The apparatus of claim 11, wherein the fastener is a cotter.

13. An apparatus comprising:
a generally arcuate member having first and second ends;
a trailer hitch ball connected to the generally arcuate member;
an elongate member attached to the first end of the generally arcuate member and to the second end of the generally arcuate member, wherein a first end of the elongate member and a second end of the elongate member extend beyond the first end of the generally arcuate member and the second end of the generally arcuate member, respectively, such that the first end of the elongate member and the second end of the elongate member are configured to allow connection to hitch links of a three-point tractor hitch; and
a plurality of hitch pin supporting brackets connected to the generally arcuate member, wherein the hitch pin supporting brackets are adapted to support a hitch pin that is adapted to connect to a third link of a three-point tractor hitch.

14. The apparatus of claim 13, further comprising:
a second tractor hitch ball that is attached to the elongate member.

15. The apparatus of claim 13, wherein the generally arcuate member is composed of a plurality of straight segments that meet at discrete angles.

16. The apparatus of claim 13, wherein the generally arcuate member, the elongate member, and the hitch pin supporting brackets form a unitary structure.

17. The apparatus of claim 16, wherein the generally arcuate member, the elongate member, and the hitch pin support brackets are welded together to form the unitary structure.

18. The apparatus of claim 13, further comprising:
first and second bores at opposite ends of the elongate member, wherein the first and second bores are adapted to accommodate a fastener.

19. The apparatus of claim 18, wherein the fastener is a cotter.

20. An apparatus comprising:
a curviform tubular member having a first end and a second end, wherein the tubular member is tapered at the first end and the second end;
first and second cylindrical rods affixed to the first end and second end of the tubular member, respectively;
a trailer hitch ball affixed to the tubular member; and first and second hitch pin support brackets affixed to the tubular member and including bores adapted to support a hitch pin between the brackets.
